(19) United States
(12) Patent Application Publication
(10) Pub. No.: US 2026/0049851 A1
(43) Pub. Date: Feb. 19, 2026

(54) ASSEMBLY FOR ATTENUATION OF PARASITIC ULTRASONIC WAVES PROPAGATING IN FLUID AND ULTRASONIC FLOWMETER

(71) Applicant: OIL&GAS METERING EQUIPMENT S.R.O, 538 51 Restoky (CZ)

(72) Inventors: Sergey PIROGOV, Lvov (UA); Oleksii KUZNETSOV, Dnipro (UA); Martin MIKAN, Restoky (CZ); Aleksandr SUPENKO, Dnipro (UA); Jaroslav MIKAN, Restoky (CZ)

(73) Assignee: OIL&GAS METERING EQUIPMENT S.R.O, 538 51 Restoky (CZ)

(21) Appl. No.: 19/101,667

(22) PCT Filed: Aug. 3, 2023
(86) PCT No.: PCT/IB2023/057861

§ 371 Date: Feb. 6, 2025

(30) Foreign Application Priority Data
Aug. 10, 2022 (CZ) PV 2022-333

(51) Int. Cl. G01F 1/667; G01F 1/66

(52) U.S. Cl. CPC G01F 1/668; G01F 1/662

(57) ABSTRACT

An assembly for attenuation of parasitic ultrasonic waves propagating in the fluid includes a body and a structure for attenuation of the parasitic ultrasonic waves arranged in the body, wherein the body defines space for fluid flow, and the structure for attenuation of parasitic ultrasonic waves includes at least one primary diffraction structure having dimensions comparable to the wavelength of the parasitic ultrasonic waves. A secondary diffraction structure is arranged on at least one primary diffraction structure having dimensions comparable to the wavelength of the parasitic ultrasonic waves. An ultrasonic flowmeter comprising the assembly is also provided.

### BACKGROUND AND SUMMARY

The present invention relates to an assembly for attenuation of parasitic ultrasonic waves propagating in fluid, and to ultrasonic flowmeter that includes the assembly. Noise can be reduced in metering of flow and improved accuracy of the flowmeter may be achieved owing to the assembly for attenuation of parasitic ultrasonic waves.

There are various types of flowmeters in the state of the art, wherein ultrasonic flowmeter is often used in laboratory settings and many other areas of application. The flowmeter typically includes a pipeline where the measured fluid flows (i.e., liquid or gas) as well as ultrasonic sensors that allow transmitting and receiving of ultrasonic measurement signal. In practice, one may usually come across with e.g., a flowmeter that comprises two ultrasonic sensors being placed opposite each other and at a distance one after another downstream the fluid. First ultrasonic sensor emits ultrasonic signal through the measured fluid towards second, opposite sensor that records time between transmitting and receiving of the signal. For a change, the second ultrasonic sensor emits the ultrasonic signal through the fluid in opposite direction, i.e., towards the first sensor. In general, transit times of the measuring signal measured in both directions differ, because in the first case the measuring signal crosses downstream the fluid and in the other case, the measuring signal crosses upstream the fluid. Fluid flow value is then calculated from the difference of times between the two transits, and pipeline geometry is used to this end.

A set of ultrasonic sensors may be arranged in a various way, e.g., more sensors may be used, wherein each ultrasonic sensor is characterized by so-called working wavelength (or frequency) of the ultrasonic sensor in the measured medium, i.e., in the fluid, i.e., wavelength of the measuring signal they emit. In practice, these working (or resonant) frequencies usually range between tens of kHz up to hundreds of kHz. Ultrasound is then considered to be waves with a frequency higher than 20 kHz, i.e., outside the audible range.

However, in practice, reliable operation of the flowmeter is usually put under burden by so-called acoustic noise being generated in the pipeline e.g., due to use of a pressure controller. The acoustic noise propagates within the fluid in the form of so-called parasitic ultrasonic waves and may also contain frequencies that correspond to working wavelength of the ultrasonic sensors in the fluid. In such a case the parasitic ultrasonic waves present as noise being superposed to the wanted signal of the sensors, which results in erroneous measurements. Therefore, there is a need to attenuate such parasitic ultrasonic waves and improve accuracy of the ultrasonic flowmeter thereby.

The attenuation of parasitic waves is disclosed e.g., in patent documents EP-934509 B1, EP1217339 A2, U.S. Pat. No. 8,955,392 B2 or WO9922207 A1, which disclose various shape structures arranged in a section of pipeline arranged upstream the ultrasonic sensors. The shape structures are provided so that they attenuate the parasitic ultrasonic waves corresponding to the working frequency of the ultrasonic sensors in the fluid based on various physical phenomena (absorption or reflection followed by destructive interferences, to name a few), and remove noise in the measured signal thereby. The shape structures may include barriers of appropriate dimensions such as various protrusions as well as various shaped grooves or holes. However, attenuation of the parasitic ultrasonic waves in these methods may be insufficient in some cases. In addition, systems based on reduction of the parasitic waves through absorption require that an appropriate absorption material, e.g., porous one, is inserted in the pipeline.

The acoustic noise is generated also in other devices and influences their correct function, i.e., in the devices not employed directly for flow measurement. These include, among others, flow baffles or acoustic filtering devices.

Therefore, a solution is needed that would permit more considerable attenuation of the parasitic ultrasonic waves be they in the ultrasonic flowmeters or other devices. The proposed solution should also be characterized in a simple structure that does not require e.g., provision of absorption material and its insertion in the pipeline.

To a certain extent, said drawbacks are eliminated by an assembly for attenuation of parasitic ultrasonic waves propagating in the fluid, wherein the assembly includes a body and a structure for attenuation of the parasitic ultrasonic waves arranged in the body, wherein the body defines space for fluid flow, and the structure for attenuation of parasitic ultrasonic waves includes at least one primary diffraction structure having dimensions comparable to the wavelength of the parasitic ultrasonic waves. The assembly according to the present invention provides a secondary diffraction structure arranged on at least one primary diffraction structure having dimensions comparable to the wavelength of the parasitic ultrasonic waves.

Whereas the dimensions of the primary diffraction structure, and in particular secondary diffraction structures comparable to the wavelength of the parasitic ultrasonic waves, the parasitic waves are diffracted (bent) and dissipated. A combination of these phenomena will cause the sound pressure behind the structure for attenuation of the parasitic ultrasonic waves downstream the fluid is lower compared to the sound pressure before the structure for attenuation of the parasitic ultrasonic waves. In a device where the assembly according to the present invention is used the parasitic ultrasonic waves are attenuated, and their negative impact on proper function of the device is attenuated, e.g., on precision of measurement in case the assembly is included in the ultrasonic flowmeter. With the secondary diffraction structure arranged on the primary diffraction structure, the attenuation of the parasitic ultrasonic waves is sufficient also for highly sensitive flowmeters.

The secondary diffraction structure is favourably provided as a needle-shaped structure comprising at least one needle-shaped element. This arrangement of the secondary diffraction structure is characterized by a simple structure that, however, reliably attenuates the parasitic ultrasonic waves in a sufficient way. As opposed to the systems based on attenuation of the parasitic waves by absorption, no absorption material is needed to be inserted in the body. The material of the needle-shaped elements does not matter, and they may be created right on the primary diffraction structure and hence, from the same material as the primary diffraction structure is made from.

Length of the needle-shaped element is favourably comparable to the wavelength of the parasitic ultrasonic waves, and thickness of the needle-shaped element is lower than the wavelength of the parasitic ultrasonic waves. A characteristic dimension of the needle-shaped element is its length, whereas its thickness may not be comparable to the wavelength of the parasitic ultrasonic waves. The lower the thickness of the needle-shaped elements (and needles sharper), the more needle-shaped elements may be arranged on the primary diffraction structure. This denser needle-shaped structure provides more distinctive attenuation of the parasitic ultrasonic waves.

Favourably, the primary diffraction structure is provided as a barrier or cavity. In point of fact, the arrangement of the primary diffraction structure as far as its shape is concerned is arbitrary, which provides a good variability for production. Dimensions of the barrier or cavity need only to be comparable to the wavelength of the parasitic ultrasonic waves, that is to say in a specific application with working wavelength of the ultrasonic sensors in the fluid.

The secondary diffraction structure is favourably arranged on the edge of the first diffraction structure for efficient attenuation of the parasitic ultrasonic waves, because sound bends and dissipates on the edges according to Huygens-Fresnel principle. By placing the secondary diffraction structure on the edge of the first diffraction structure (be it solid barrier or a cavity), the bending and dissipation are substantially increased.

To a certain extent, said drawbacks are also eliminated by an ultrasonic flowmeter including the assembly according to the present invention, wherein the ultrasonic flowmeter further includes a measuring section behind the structure for attenuation of the parasitic ultrasonic waves downstream the fluid adapted for fluid flow rate measurement, wherein the measuring section includes at least one ultrasonic sensor adapted for transmitting a measuring signal of working wavelength of the ultrasonic sensor in the fluid, and at least one ultrasonic sensor adapted for receiving of the measuring signal of working wavelength of the ultrasonic sensor in the fluid. The essence of the ultrasonic flowmeter according to the present invention is that the dimensions of the secondary diffraction structure are comparable to the working wavelength of ultrasonic sensors in the fluid. This attenuates the parasitic ultrasonic waves that comprise frequencies corresponding to the working wavelength of the ultrasonic sensors and the working wavelength of the ultrasonic sensors in the fluid. In this way noise is significantly reduced and precision of the ultrasonic flowmeter improved.

### BRIEF DESCRIPTION OF THE DRAWINGS

The present invention is further explained by exemplary embodiments described with reference to the following drawings, in which:

FIG. 1 illustrates schematically in longitudinal section an ultrasonic flowmeter comprising the assembly according to the present invention with a structure for attenuation of the parasitic ultrasonic waves in the first exemplary embodiment,

FIG. 2a illustrates schematically in longitudinal section an ultrasonic flowmeter comprising the assembly according to the present invention with a structure for attenuation of the parasitic ultrasonic waves in the second exemplary embodiment,

FIG. 2b illustrates schematically in cross section an ultrasonic flowmeter comprising the assembly according to the present invention with a structure for attenuation of the parasitic ultrasonic waves in the second exemplary embodiment,

FIG. 3 illustrates schematically in longitudinal section an ultrasonic flowmeter comprising the assembly according to the present invention with a structure for attenuation of the parasitic ultrasonic waves in another exemplary embodiment,

FIG. 4 illustrates schematically in longitudinal section an ultrasonic flowmeter comprising the assembly according to the present invention with a structure for attenuation of the parasitic ultrasonic waves in another exemplary embodiment, and

FIG. 5 illustrates schematically in cross section an ultrasonic flowmeter comprising the assembly according to the present invention with a structure for attenuation of the parasitic ultrasonic waves in another exemplary embodiment.

### DETAILED DESCRIPTION

In what follows, the invention will be described on exemplary embodiments with reference to the drawings.

The assembly according to the present invention includes a body 1 and a structure 2 for attenuation of the parasitic waves arranged in the body 1. Although the assembly may be used for attenuation of the parasitic waves in various devices, the assembly will be described for better understanding in association with an embodiment where the assembly is included in an ultrasonic flowmeter. It is the ultrasonic flowmeter, where the assembly for attenuation of the parasitic waves finds its greatest use because the so-called sound pressure in the form of the parasitic ultrasonic waves may comprise frequencies (or wavelengths) that correspond to the working frequency of the ultrasonic sensors 4 of the flowmeter or working wavelength of the ultrasonic sensors 4 in the fluid.

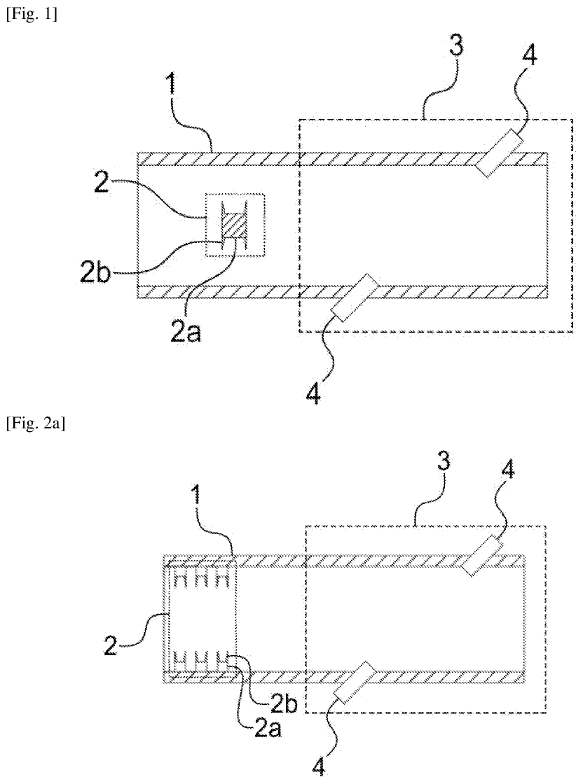

The ultrasonic flowmeter comprising the assembly according to the present invention is illustrated in various exemplary embodiments in FIG. 1 to FIG. 5, wherein in the following part reference is made to FIG. 1 for description of the ultrasonic flowmeter.

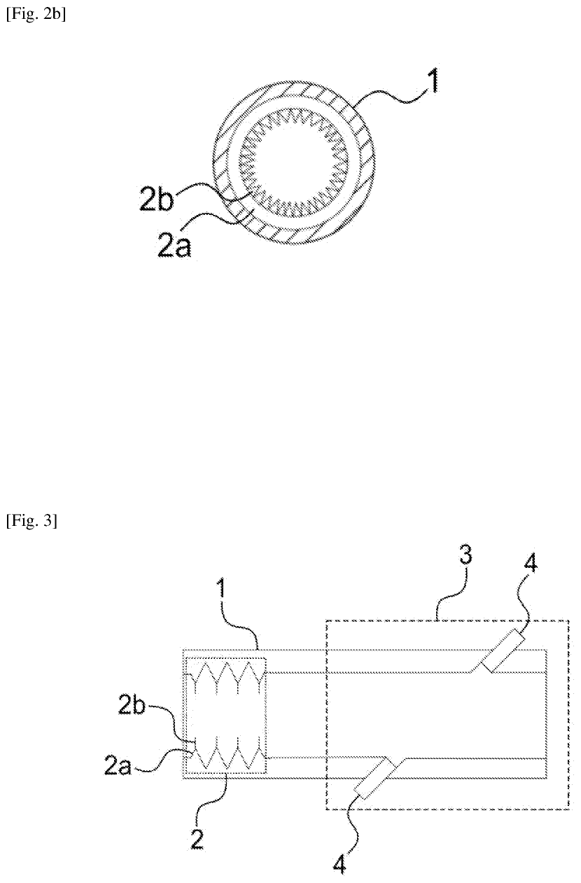

As illustrated in FIG. 1, the ultrasonic flowmeter comprises the assembly for attenuation of the parasitic waves; therefore, it comprises the body 1 defining the space for flowing of fluid and the structure 2 for attenuation of the parasitic waves arranged in the body 1. For example, the body 1 is provided as a pipeline of round cross section as can be seen in FIG. 2b and FIG. 5, and it may correspond to a supply pipeline of the ultrasonic flowmeter, for example. Alternatively, the body has a different shape or a different cross section, provided that the shape defines space for flowing of fluid, wherein the fluid refers to either liquid or gas according to standard terminology used.

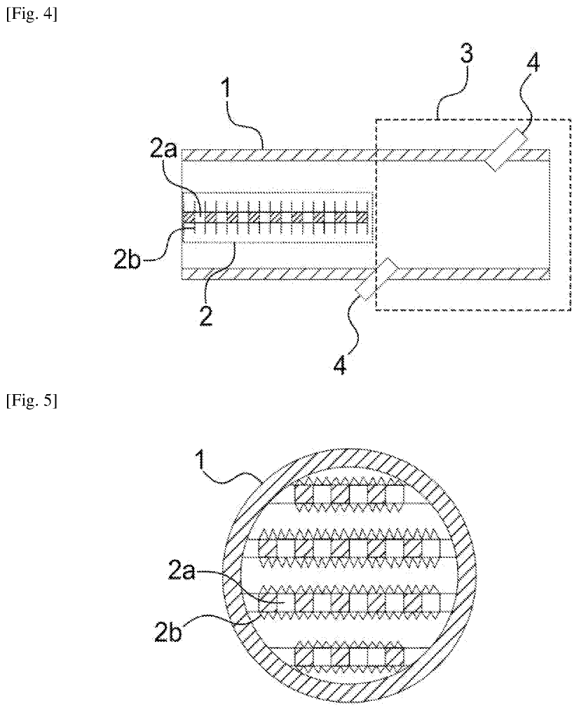

The ultrasonic flowmeter further comprises a measuring section 3 used for measuring of flowrate of the fluid through the body 1. The measuring section 3 is illustrated in FIG. 1 (as well as in FIG. 2a, FIG. 3, and FIG. 4) by a rectangle with dashed lines, and arranged behind the structure 2 for attenuation of the parasitic ultrasonic waves downstream the fluid. In FIG. 1, FIG. 2a, FIG. 3, and FIG. 4, fluid flows from left to the right.

In first exemplary embodiment, the measuring section 3 comprises two ultrasonic sensors 4 arranged on the body 1, for example, they are attached thereto, and located in opposite direction at a certain distance one after another downstream the fluid. Each of the pair of the ultrasonic sensors 4 is adapted for transmitting and receiving of a measuring signal of working wavelength of the ultrasonic sensor 4 in the fluid. In the first exemplary embodiment, the first ultrasonic sensor 4 is specifically adapted for transmitting of the measuring signal through the fluid towards the second, opposite ultrasonic sensor 4, wherein the opposite ultrasonic sensor 4 is adapted for receiving of the measuring signal, i.e., the ultrasonic signal emitted by the first ultrasonic sensor 4. Therefore, the ultrasonic sensors 4 are positioned so that they can see each other. With the second ultrasonic sensor 4, transit time of the measuring signal through the fluid, i.e., time between transmitting and receiving of said signal, is recorded. Furthermore, the second ultrasonic sensor 4 is adapted in the first exemplary embodiment for transmitting of the measuring signal in opposite way, i.e., through the fluid towards the first ultrasonic sensor 4, wherein the transit time of the measuring signal, i.e., time between transmitting and receiving of said signal, is recorded by the first ultrasonic sensor 4. Due to the flowing of fluid, the transit times recorded in both directions differ as in the first case the measuring signal crosses the fluid slantwise downstream the fluid flow, and in the second case the measuring signal crosses the fluid slantwise upstream the fluid flow. The fluid flow value is then calculated just from the difference between these transit times and with the use of the body 1 geometry. Favourably, the flowmeter comprises an appropriate computing unit to calculate the fluid flow.

Alternatively, the measuring section 3 comprises a different number of the ultrasonic sensors 4, or a different arrangement is used, in line with all known arrangements of the ultrasonic flowmeter, provided that the embodiment permits measuring of the fluid flowing through the body 1. The measuring section 3 may comprise more than two ultrasonic sensors 4 with mutually identical working frequency of the ultrasonic sensors 4. In principle, the measuring section 3 must comprise at least one ultrasonic sensor 4 adapted for transmitting of the measuring signal of working wavelength of the ultrasonic sensor 4 in the fluid, and at least one ultrasonic sensor 4 adapted for receiving of the measuring signal of working wavelength of the ultrasonic sensor 4 in the fluid, wherein the ultrasonic sensors 4 may also be embodied by the only and the same ultrasonic sensor 4. Alternatively, the measuring section 3 may comprise only one ultrasonic sensor 4 being adapted for transmitting and receiving of the measuring signal, wherein such ultrasonic sensor 4 may be installed, for example, orthogonally to the fluid flow, and receives the measuring signal reflected from the opposite wall of the pipeline. Due to shifting of a sound ray and radiation diagram of the ultrasonic sensor 4, a voltage signal depends on speed/flowrate of the measured fluid.

The wavelength of the measuring signal emitted by the ultrasonic sensors 4 corresponds to so-called working wavelength of the ultrasonic sensors 4 in the fluid, wherein rather working (or resonant) frequency f is used in practice, being bound by simple relationship with the wavelength λ:

$$f = \frac{v}{λ} ,$$

where v represents propagation speed of the ultrasonic waves in the fluid (i.e., in liquid—e.g., in water, or gas—e.g., in air). The working frequency of the ultrasonic sensors 4 is in practice usually from tens of kHz to hundreds of kHz. When water is used as the fluid, higher frequency may be used as well, e.g., 1,000 kHz.

In practice, so-called acoustic noise may propagate in the fluid, of which spectrum may have frequencies from tens of Hz up to hundreds of kHz or more than 1,000 kHz, wherein the frequencies that correspond to the working frequency of the ultrasonic sensors 4 may be identified as parasitic. Or, the parasitic ultrasonic waves may be defined, and their frequencies correspond just to the working frequency of the ultrasonic sensors 4. These parasitic ultrasonic waves then appear as noise being superposed to a wanted signal of the ultrasonic sensors 4, which results in erroneous measurements. Therefore, the ultrasonic flowmeter according to the present invention also includes the structure 2 for attenuation of the parasitic ultrasound waves.

The structure 2 for attenuation of the parasitic ultrasonic waves is arranged in the body 1 before the measuring section 3 downstream the fluid, and comprises at least one primary diffraction structure 2a and at least one secondary diffraction structure 2b arranged on the primary diffraction structure 2a as schematically illustrated, for example, in FIG. 1. The primary diffraction structure 2a is provided as any shape element with dimensions comparable to the wavelength of the parasitic ultrasonic waves, i.e., comparable to the working wavelength of the ultrasonic sensors 4 in the fluid, for as the assembly according to the present invention is described as employed in an ultrasonic flowmeter. In case the assembly according to the present invention is employed in a different device, the wavelength of the parasitic ultrasonic waves corresponds to the working wavelength in the fluid for that device.

Due to the facts the dimensions of the primary diffraction structure 2a are comparable to the wavelength of the parasitic ultrasonic waves, diffraction (bending) of the parasitic ultrasonic waves occurs on the primary diffraction structure 2a. Bending of the parasitic ultrasonic waves is accompanied by dissipation on the primary diffraction structure 2a followed by interference. The combination of these physical phenomena cause that the sound pressure behind the primary diffraction structure 2a downstream the fluid is lower than the sound pressure before the primary diffraction structure 2a and therefore, the parasitic ultrasonic waves are attenuated including their impact on the measured signal. Based on generally acceptable definition, the dimensions comparable to the wavelength refer to the dimensions within the interval from ⅛ of the wavelength up to about several wavelengths.

The primary diffraction structure 2a may be provided as a barrier or cavity, wherein the barrier refers to a solid element that impedes fluid flow, i.e., a projection from the body 1, for example. On the contrary, a cavity refers to an element that supports the fluid flow. For example, the cavity may be a hole formed in a plate received in the body 1. In these cases, the diffraction occurs when height or length of these projections is comparable to the working wavelength of the ultrasonic sensors 4 in the fluid, for example, or if diameter of said hole is comparable to the working wavelength of the ultrasonic sensors 4 in the fluid. Thus, specific dimensions depend on value of the working frequency of the ultrasonic sensors 4. With gas ultrasonic flowmeter (propagation speed v about 340 m/s) and working frequency 100 kHz of the ultrasonic sensors 4, the wavelength, i.e., ideal value of the dimension, is about 3.4 mm. For 200 kHz working frequency, the wavelength is 1.7 mm. With ultrasonic water meter (propagation speed v about 1,500 m/s) and working frequency 1,000 kHz of the ultrasonic sensors 4, the wavelength is 1.5 mm. Favourably, the dimension of the primary diffraction structure 2a (as well as of the secondary diffraction structure 2b) is selected to 2 mm, for example. Alternatively, the dimension is selected as a different value lying in the interval from about 0.5 mm to about 10 mm, or outside the interval depending on the working wavelength of the ultrasonic sensors 4 in the fluid used so that it is true that the dimension is comparable to the working wavelength of the ultrasonic sensors 4 in the fluid. Individual embodiments of the primary diffraction structure 2a are illustrated in the attached figures as described below.

The secondary diffraction structure 2b is arranged on the primary diffraction structure 2a, wherein it is specifically arranged on the edge of the primary diffraction structure 2a as seen, for example, in FIG. 1. The dimensions of the secondary diffraction structure 2b are also comparable to the wavelength of the parasitic ultrasonic waves to be attenuated, i.e., comparable to the working wavelength of the ultrasonic sensors 4 in the fluid. The secondary diffraction structure 2b is provided as a needle-shaped structure comprising at least one needle-shaped element, wherein the characteristic dimension of the needle-shaped element is length thereof. The length of the needle-shaped element is favourably selected to be about 2 mm. Alternatively, the needle-shaped element has a different length, e.g., in the interval from about 0.5 mm to about 10 mm, or outside the interval depending on the working wavelength of the ultrasonic sensors 4 in the fluid used so that it is true that the length is comparable to the working wavelength of the ultrasonic sensors 4 in the fluid, i.e., with the wavelength of the parasitic ultrasonic waves to be attenuated. The thickness of the needle-shaped element is lower than the length thereof, and does not have to be comparable to the wavelength of the parasitic ultrasonic waves. The thickness may be lower than about 0.5 mm, wherein it generally changes along the length of the needle-shaped element. As seen, for example, in FIG. 1, the needle-shaped element progressively narrows down from the place where it emerges from the primary diffraction structure 2a and becomes pointed on the other end. The needle-shaped element is also well visible in figures illustrating the ultrasonic flowmeter in cross section, i.e., FIG. 2b and FIG. 5.

The secondary diffraction structure 2b having form of a needle-shaped structure favourably comprises a higher number of needle-shaped elements to achieve more significant attenuation of the parasitic ultrasonic waves, hence more significant noise reduction, and improving accuracy of the ultrasonic flowmeter. Due to the fact the dimensions of the secondary diffraction structure 2b (more specifically, length of the needle-shaped element) are comparable to the wavelength of the parasitic ultrasonic waves to be attenuated, diffraction (bending) of these parasitic ultrasonic waves occurs on the secondary diffraction structure 2b. Bending of the parasitic ultrasonic waves is accompanied by dissipation on the secondary diffraction structure 2b followed by interference. The combination of these physical phenomena results in that the sound pressure behind the secondary diffraction structure 2b arranged on the primary diffraction structure 2a downstream the fluid is lower than the sound pressure before the secondary diffraction structure 2b. Hence, the parasitic ultrasonic waves and their impact on the measured signal are attenuated even more.

Reliability of the secondary diffraction structure 2b in the form of the needle-shaped elements was also confirmed in an experiment, where the body 1 (pipeline) received a plate without holes in the first case, and a plate with 2 mm holes in diameter in the second case, and a plate with 2 mm holes in diameter along which edges the secondary diffraction structure 2b are arranged in the form of the needle-shaped elements. A voltage-detecting sensor was installed behind the plate downstream the fluid flow and the values from the sensor served for making a relative estimation of the sound pressure. While in the first case the sound pressure level was N dB, in the second case the sound pressure decreased to (N−3) dB, and in the third case even to (N−6) dB and more. Hence, the use of the secondary diffraction structure 2b in the form of the needle-shaped elements resulted in more than doubled signal attenuation. A resonant frequency of 170 kHz was used in the experiment.

The individual exemplary embodiments of the structure 2 for attenuation of the parasitic ultrasonic waves, i.e., embodiment of the primary diffraction structure 2a and the secondary diffraction structure 2b arranged thereon, are illustrated in the attached figures. In the figures, the structure 2 for attenuation of the parasitic ultrasonic waves is shown as a rectangle from dashed lines for better understanding.

FIG. 1 shows that the secondary diffraction structure 2b is provided as a plurality of needle-shaped elements being arranged on the edges of the barrier that corresponds to the primary diffraction structure 2a. Both dimensions of the barrier and length of the needle-shaped elements are comparable to the wavelength of the parasitic ultrasonic waves.

FIG. 2a and FIG. 2b show the second exemplary embodiment of the structure 2 for attenuation of the parasitic ultrasonic waves. In this embodiment, the primary diffraction structure 2a is provided as a projection radially extending from the body 1, wherein the round shape of the projection can be best seen on the cross section in FIG. 2b. The needle-shaped elements are arranged on inner side of the projection, with their pointed ends facing the centre of the body 1. Favourably, the structure 2 for attenuation of the parasitic ultrasonic waves comprises a higher number of these primary diffraction structures 2a in the form of radial projections, wherein three such projections are shown in FIG. 2a. Both dimensions of the projections and length of the needle-shaped elements are comparable to the wavelength of the parasitic ultrasonic waves.

Another exemplary embodiment of the structure 2 for attenuation of the parasitic ultrasonic waves is shown in FIG. 3, wherein the primary diffraction structure 2a is provided as a thread formed in the inner wall of the body 1. On top of the thread, i.e., on the locations of the thread being nearest to the centre of the body 1, there are arranged the needle-shaped elements representing the secondary diffraction structure 2b. Both dimensions of thread (i.e., the pitch distance of threads) as well as length of the needle-shaped elements are comparable to the wavelength of the parasitic ultrasonic waves.

Another exemplary embodiment of the structure 2 for attenuation of the parasitic ultrasonic waves is shown in FIG. 4, wherein the structure 2 for attenuation of the parasitic ultrasonic waves comprises a plurality of holes corresponding to the primary diffraction structure 2a, and a plurality of the needle-shaped elements corresponding to the secondary diffraction structure 2b. Both diameter of the holes as well as the length of the needle-shaped elements are comparable to the wavelength of the parasitic ultrasonic waves. The structure 2 for attenuation of the parasitic ultrasonic waves corresponds to a perforated flow baffles similarly to the embodiment in FIG. 5.

Alternatively, the primary diffraction structure 2a may be provided in a different way, or the secondary diffraction structure 2b may be arranged in the form of the needle-shaped elements in a different way, for example, with different number or placement of these needle-shaped elements, if the dimensions of the primary diffraction structure 2a and of the secondary diffraction structure 2b are comparable to the wavelength of the parasitic ultrasonic waves to be attenuated.

### INDUSTRIAL APPLICABILITY

In addition to noise reduction of the ultrasonic flowmeter, the assembly for attenuation of the parasitic ultrasonic waves may be used also in other devices, for example, in the flow barriers or acoustic filtering devices.

### REFERENCE SIGNS LIST

1 body
2 structure for attenuation of the parasitic ultrasonic waves
2a primary diffraction structure
2b secondary diffraction structure
3 measuring section
4 ultrasonic sensor

1. An assembly for attenuation of parasitic ultrasonic waves propagating in the fluid, wherein the assembly includes
a body and
a structure for attenuation of the parasitic ultrasonic waves arranged in the body,
wherein the body defines a space for fluid flow, and
the structure for attenuation of the parasitic ultrasonic waves includes at least one primary diffraction structure having dimensions comparable to the wavelength of the parasitic ultrasonic waves,
wherein a secondary diffraction structure is arranged on at least one primary diffraction structure having dimensions comparable to the wavelength of the parasitic ultrasonic waves.

2. The assembly according to claim 1, wherein the secondary diffraction structure is provided as a needle-shaped structure comprising at least one needle-shaped element.

3. The assembly according to claim 2, wherein the length of the needle-shaped element is comparable to the wavelength of the parasitic ultrasonic waves, and thickness of the needle-shaped element is lower than the wavelength of the parasitic ultrasonic waves.

4. The assembly according to claim 1, wherein the primary diffraction structure is provided as a barrier or a cavity.

5. The assembly according to claim 1, wherein the secondary diffraction structure is arranged on an edge of the first diffraction structure.

6. An ultrasonic flowmeter comprising the assembly claim 1,
wherein the ultrasonic flowmeter further includes a measuring section behind the structure for attenuation of the parasitic ultrasonic waves downstream the fluid adapted for fluid flow rate measurement,
wherein the measuring section includes
at least one ultrasonic sensor adapted for transmitting a measuring signal of working wavelength of the ultrasonic sensor in the fluid, and
at least one ultrasonic sensor adapted for receiving of the measuring signal of working wavelength of the ultrasonic sensor in the fluid,
wherein the dimensions of the secondary diffraction structure are comparable to the working wavelength of the ultrasonic sensors in the fluid.
